(19) United States
(12) Patent Application Publication
(10) Pub. No.: US 2007/0185776 A1
(43) Pub. Date: Aug. 9, 2007

(54) SYSTEM AND METHOD FOR PRESENTING CONSUMER PURCHASING OPPORTUNITIES THROUGH MULTIPLE COMMUNICATION AND DISPLAY MEDIUMS

(75) Inventors: Justin A. Nguyen, Carlsbad, CA (US); Roger Dev, Durham, NH (US)

Correspondence Address: BOURQUE & ASSOCIATES;INTELLECTUAL PROPERTY ATTORNEYS, P.A., 835 HANOVER STREET, SUITE 301, MANCHESTER, NH, 03104, US

(73) Assignee: NextChoice, Inc., Portsmouth, NH (US)

(21) Appl. No.: 11/537,044

(22) Filed: Sep. 29, 2006

Related U.S. Application Data
(63) Continuation-in-part of application No. 10/602,203, filed on Jun. 24, 2003.
(63) Continuation-in-part of application No. 10/620,717, filed on Jul. 16, 2003.
(63) Continuation of application No. 11/176,097, filed on Jul. 7, 2005.
(63) Continuation of application No. 10/620,719, filed on Jul. 16, 2003.
(63) Continuation of application No. 11/513,897, filed on Aug. 31, 2006.

(51) Int. Cl. G06Q 30/00

(52) U.S. Cl. 705/26

(57) ABSTRACT

An ordering system allows a consumer to interact with an ordering system so as to view advertising or promotions from merchants and to order products or services from merchants through the ordering system. A consumer utilizes an interactive consumer interface device to interface with the ordering system. The interactive consumer interface device receives information from and displays information to the consumer. The ordering system may keep a profile of the consumer. The profile may include consumer preference information as well as order payment information. A merchant interfaces with the ordering system and can decide on a targeted consumer profile to which merchant advertising or promotional material may be displayed. When a consumer places an order which includes order delivery information, the ordering system determines when the order production should take place in order to be able to fulfill the order in accordance with the appropriate delivery information concerning the order.

### CROSS-REFERENCE TO RELATED APPLICATIONS

This application is a continuation-in-part of U.S. patent application Ser. Nos. 10/602,203 and 10/620,717. This application is also a continuation of U.S. patent application Ser. No. 11/176,097 which claims priority from U.S. patent application Ser. No. 10/602,703 (now U.S. Pat. No. 6,940,393); U.S. patent application Ser. No. 10/620,719; and U.S. patent application Ser. No. 11/513,897, all fully incorporated herein by reference.

### TECHNICAL FIELD

The present invention relates to product ordering systems and more particularly, relates to a system and method that can selectively and intelligently present ordering opportunities to consumers and then subsequently process a consumer's order.

### BACKGROUND INFORMATION

There is a great diversity in customs and lifestyle for people throughout the world, but there is one constant for peoples of all cultures and preferences: Everyone eats on a daily basis. As people travel, commute, conduct business, or enjoy leisure activities, they want to find food that they enjoy, order it in convenient ways, and receive it without waiting or hassles.

A diverse set of food merchants have risen to meet these needs, offering everything from drive-through quick service to take-home gourmet meals and fine-dining experiences. These merchants, whether local boutiques or global restaurant chains, are competing for consumers' mind-share and money. A system that can selectively and intelligently present ordering opportunities to consumers, whether they are on the road or at home watching television, would provide value and convenience to both consumers and merchants. Such a system would match consumer dining preference to advertising merchants, and allow customers to order from a multitude of new touchpoints.

The next few decades will see a multitude of new interactive digital devices appear and others that currently exist will become ubiquitous. This affords consumers a wide range of services that will be available through any of these digital “touchpoints”. These services include not only traditional information-services, but also transactional services allowing customers to purchase items or services from any of these touchpoints. While consumers will view these touchpoints as a convenient point of access for services, merchants will view these touchpoints as opportunities to market their products and services. Merchants will vie for visibility within these new media and will be willing to pay for access to the consumers who utilize those touchpoints.

One of the new features of these touchpoints that makes them different from some of the traditional media through which merchants reach their consumers, is that they can identify the consumer and his/her physical location. This allows a targeted “push” of advertisements for merchants or products that are expected to appeal to the individual consumers accessing the touchpoint and that have outlets in the consumer's vicinity.

Some examples of these touchpoints, current and anticipated, include, but are not limited to: Home TV—Using digital set-top boxes or customer provided add-on appliances; Private Interactive TV—As provided in many hotel rooms; Cell Phones and Hand-held Computers—Interactive, networked cell-phone and PDA devices are prevalent today, and provide platforms with enough capability to provide additional services; Internet Portals; Public Kiosks—For example, in malls or office parks; Private Kiosks—For example, in retail outlets or movie theatres; In-vehicle Navigation Systems—Interactive displays, already available in luxury vehicles, will become a commonplace feature in automobiles. They have network capability and as discussed herein may become a retail or transaction terminal for the driver (when the car is parked) or passengers (when the car is moving); Operator-Assisted Service Portals—These systems are already in-use in a large number of automobiles. In this environment, the customer interacts with a human operator, or with an automated attendant backed-up by a human operator. The automated-attendant or human operator's interaction can be guided by an automated system behind the scenes; Gaming Machines—Many of today's gaming machines contain large interactive display capabilities and networked computers. It is anticipated that additional services will be provided on these machines such as those described below; and Fuel Pumps—Newer gas pumps include interactive display systems capable of carrying enhanced content. These will ultimately be used to advertise, select and pay for merchandise while fuel is being dispensed.

The transactional capabilities of these media include the capability to order and pay for the requested goods or services. This may take the form of traditional Internet Commerce in which the goods are shipped to the consumer and received at a later date, or may be delivered digitally (e.g., movies or music). A third possibility is that the transaction may be routed to an outlet in the local vicinity of the consumer which can prepare the ordered items and either deliver them to the consumer or have them available for pickup. This later class of transaction will be referred to as “Goods-On-Demand”. It is appropriate for a wide class of merchants including chain outlets (food, grocery, floral, dry-goods) and local boutique outlets which may direct their advertising only to consumers that are in the local vicinity of their outlet.

In addition to the consumer and the merchant, there is another party involved in this process: the provider of the touchpoint medium. This party is known generically as the “Service Provider”. Examples of Service Providers include: Cable Companies, Restaurant Chains providing “Private” kiosks, Gaming outlets, Independent providers of public terminals, hotels, and any number of other new-media companies that may spring up in the future. Service Providers may seek their own revenues in a number of ways: through a subscription or transactional fee to the consumer; through an advertising or referral fee charged to the merchant; or by a combination of the above. Merchant Service Providers may also provide the touchpoint as an attraction to bring consumers to their outlets (e.g., airlines, gaming, automobile manufacturers).

In order to realize the capabilities described above in a ubiquitous way across various touchpoints, a mechanism and method must exist to coordinate the activities of the Service Providers, Merchants, and Consumers involved in the process. The present invention is directed, in part, to a system and method including a set of processes and mechanisms that support and fully deploy this type of interaction. The embodiment utilizes these methods to provide a Pervasive Food-On-Demand capability, however, one skilled in the art will immediately realize that the present invention can be readily utilized in a much broader retail context in any one of many industries providing consumer products and/or services.

### SUMMARY

The present invention features a consumer ordering system. The ordering system includes an interactive consumer interface device which is configured for at least allowing a consumer to interact with the ordering system. The interactive consumer interface device allows the consumer to transmit information from the consumer to the system and for receiving information from the ordering system. Information received from the consumer may include, for exemplary purposes only, consumer identification information, order information, present geographic location as well as payment information. The interactive consumer interface device is also configured for displaying information to the consumer. The displayed information may include advertising, a full or partial list of products or services which may be purchased by the consumer or other information.

The ordering system also includes a consumer profiling sub-system which is responsive to the interactive consumer interface device, for receiving information provided by the consumer and for acting on and/or storing that information.

The ordering system also includes a merchant subscription sub-system which is designed and configured for allowing a merchant of products or services to define one or more characteristics related to the merchant's offer for sale of its products or services and for determining what information to provide to the consumer. Information provided to the consumer may include advertising information or a selection of items or services which may be offered for sale to and purchased by the consumer. The merchant subscription subsystem is configured to allow one or more merchants to define the details of consumers it wishes to target, for determining what advertisements or promotional displays to provide to a consumer and under what circumstances they should be provided to one or more targeted consumers. The merchant subscription subsystem is also configured for allowing one or more merchants to enter a fee structure by which a merchant agrees to pay a service provider for providing advertisements or promotions to a consumer.

The ordering system further includes a merchant interaction system which is configured for receiving at least merchant identification information relative to a product, service or advertisement and for providing merchant specific information to the consumer. The merchant interaction system is also configured for receiving payment from the consumer for products or services ordered. Also included is a merchant production subsystem, which is responsive to the merchant interaction subsystem and also coupled to the provider of a merchant's products or services, for receiving an order from the consumer and for scheduling for processing the consumer's order for products or services.

The ordering system is configured, in one embodiment, to allow a repeat or return consumer to identify him or herself to the ordering system and to allow the ordering system to present a menu of previously ordered or “favorite” items preferred by the consumer for reordering. The ordering system also allows a consumer to determine when and where the ordered products or services are to be delivered. In this manner, a consumer may order products or services for pickup at some scheduled time in the future and from a specific location. The consumer may also order from a first location for pickup or delivery of the products or services at a different location. An ordering system in accordance with the present invention allows the system to submit orders directly into the production queue of a local provider of the products or services in such a way as to direct the production of the order or service in accordance with the workload of the particular provider of the products or services.

An ordering system in accordance with the present invention also allows two or more merchants to compete for the ability to display advertisement or promotions to a consumer. Utilizing a variety of payment schemes, merchants may compete for the right to present their advertisements or promotions to consumers. The display of advertisements or promotions to consumers on behalf of merchants may be charged to the merchant based on one of more of several methods including per presentation, per selection by the consumer, per purchase, as a percent of the purchase price, at a flat rate per time period, at a fixed rate per incident, based on a dynamic auction pricing or based on one or more “affinity” factors. In addition to the selection of merchant pricing based on an affinity factor, the actual selection of the merchant may be so determined.

The present system also allows a merchant to filter their advertising or promotion to a consumer based upon factors such as geographic location of the consumer, time of the day, day of the week, consumer clustering, type of interactive device being utilized by the consumer, weather, temperature, national or international financial statistics (such as NASDAQ value, Dow Jones value, etc.) as well as display constraints of the interactive consumer interface device being utilized by the consumer.

An additional feature the present invention is an ordering system that allows a consumer to be recognized using one or more identification attributes including, but not limited to, biometric information, consumer or law again information, and the recognition of one or more cards (credits cards, loyalty cards, etc.) in the name of the consumer. An additional feature of the present invention is the ability for a consumer to be recognized or identified at one merchant's site by one or more identification attributes presented at another merchant's site. Consumers may also be identified anonymously such that no private information related to the consumer may be discovered. The present system allows the activities of a single consumer to be tracked across multiple merchants and merchant outlets. In addition, the present ordering system allows one or more merchants to store consumer data that is not available to other merchants. The present invention also allows consumers to be dynamically grouped into “clusters” based on some common criteria.

It is important to note that the present invention is not intended to be limited to a device or method which must satisfy one or more of any stated or implied objects or features of the invention. It is also important to note that the present invention is not limited to the preferred, exemplary, or primary embodiment(s) described herein. Modifications and substitutions by one of ordinary skill in the art are considered to be within the scope of the present invention, which is not to be limited except by the allowed claims and any legal equivalents thereof.

### BRIEF DESCRIPTION OF THE DRAWINGS

These and other features and advantages of the present invention will be better understood by reading the following detailed description, taken together with the drawings wherein:

FIG. 1 is schematic diagram of an ordering system in accordance with the present invention;

FIG. 2 is a more detailed schematic diagram of one embodiment of an ordering system implementing the present invention;

FIG. 3 as a block diagram illustrating various data utilized by the ordering system in accordance with the present invention and showing data ownership;

FIG. 4 is a diagram illustrating certain various data structures utilized in accordance with one embodiment of the present invention;

FIG. 5 is a block diagram illustrating data processing to and from the consumer profiling subsystem;

FIG. 6 is a flow chart and block diagram illustrating the steps involved in pricing a merchant in advertising in accordance with one aspect of the present invention;

FIG. 7 is a flow chart and block diagram illustrating the steps involved in conducting an auction price did in accordance with the present invention;

FIG. 8 is a flow chart describing the computation for the affinity factor according to one aspect of the present invention; and

FIG. 9 is a block diagram illustrating the various database table layouts in the Merchant Subscription Subsystem.

### DETAILED DESCRIPTION OF THE PREFERRED EMBODIMENTS

The following terms are used throughout the present application and the following definitions are provided as an aid to understanding such terms. To the extent such terms have plain and ordinary meanings, they should be given such plain and ordinary meanings and modified and/or supplemented by the following:

Advertisement—A visual, or auditory element that a touchpoint user can detect and (optionally) select (i.e. activate). In this application, an advertisement is presented in the context of a promotion, that may be paid for by a merchant. Selection of an advertisement may result in an expanded advertisement (e.g. full-screen video) or may invoke an ordering facility;

Campaign—A defined set of promotions on behalf of a merchant implemented by a service provider (see Promotion and service provider below);

Co-Display Constraint—A rule that inhibits the display of a promotion whenever certain other merchant's promotions are present. This can be used, for example, to prevent the promotion of competing merchants at the same time. It can also be used to prevent the simultaneous presentation of multiple promotions from the same merchant;

Consumer—An individual, family, or group that might potentially make purchases through a touchpoint. Consumers are the target for promotions and are the (potential) customers of merchants and in some cases service providers;

Goods-On-Demand—A subset of electronic retailing in which consumers can order goods using various touchpoints, that get prepared or packaged at a local outlet run by, or affiliated with the merchant. Once prepared, the goods may be delivered to the consumer's home or office, or may be made available for the consumer to pick-up at the outlet;

Merchant—A purveyor of goods or services who makes those goods or services available through a touchpoint. In the context of this system, a merchant will typically have one or more outlets where these goods or services are provided, or from where they are delivered to consumers. A merchant may be (or represent) the operator of a single outlet, multiple outlets, or an entire chain of outlets;

Outlet—A single point-of-presence for a merchant. This is typically a store or restaurant, but could also be, for example, a delivery depot;

Pervasive Food-On-Demand—One embodiment of the technology described herein, providing a touchpoint independent mechanism for ordering food and related products for pickup or delivery at local outlets, and embodying “push” technology for delivery of targeted advertisements to the touchpoints;

Presentation—The act of making a promotion accessible to a consumer, for instance by placing a graphic on a screen or enabling a choice on a voice menu. Once presented, a promotion may be selected by a consumer (see selection below);

Promotion—An individual advertisement or opportunity that can be presented to a consumer at a touchpoint by a service provider on behalf of a merchant. The consumer may ignore the promotion, may be required to dismiss it, or may select it. By selecting it, the consumer is presented with additional information and/or allowed the opportunity to make a purchase;

Service Provider—An organization that deploys, operates, and/or maintains one or more touchpoints to which consumers have access. Service providers may charge merchants for enabling promotions to be presented to the service provider's consumers. Examples of service providers include: Cable TV Operators, Restaurant Chains, Casinos, Internet Portal Operators, etc.;

Selection—The act, by a consumer, of indicating interest in a promotion. This could be, for example, by touching or otherwise activating a graphical item, by accepting a query, or by vocally indicating an interest. It is anticipated that in future implementations using eye-motion detection, visually lingering on the advertisement may be considered selection; him[????]

Temporal Affinity—An external factor or factors that increase the value of a promotional activity. Examples include: non-promotion related touchpoint programming (e.g., TV show), sporting-events, gaming winnings, stock-market performance, etc. Affinities can also be negative, indicating that the value of the promotion is decreased by such external factors; and

Touchpoint—An interactive medium accessible to consumers that is capable of a) Displaying advertisements b) Allowing consumer selection of promotions and c) Allowing the initiation of purchases of merchant goods or services.

The present invention, as explained using the Pervasive Food-On-Demand embodiment, defines a system that is capable of handling all of the aspects of the new media transactions as described above. It does not detail how the capabilities are presented through a given touchpoint medium but rather, focuses on the supporting infrastructure that supports these classes of transactions on a large-scale, ubiquitous basis.

From the consumer's point of view, advertisements are “pushed” onto their touchpoint at times and circumstances that seem to “anticipate” their needs and likes. They may appreciate that by accepting these advertisements, the cost of their service subscription is reduced. They may also appreciate that the advertisements are targeted to items of interest to them and that they are not bombarded by superfluous untargeted advertisements.

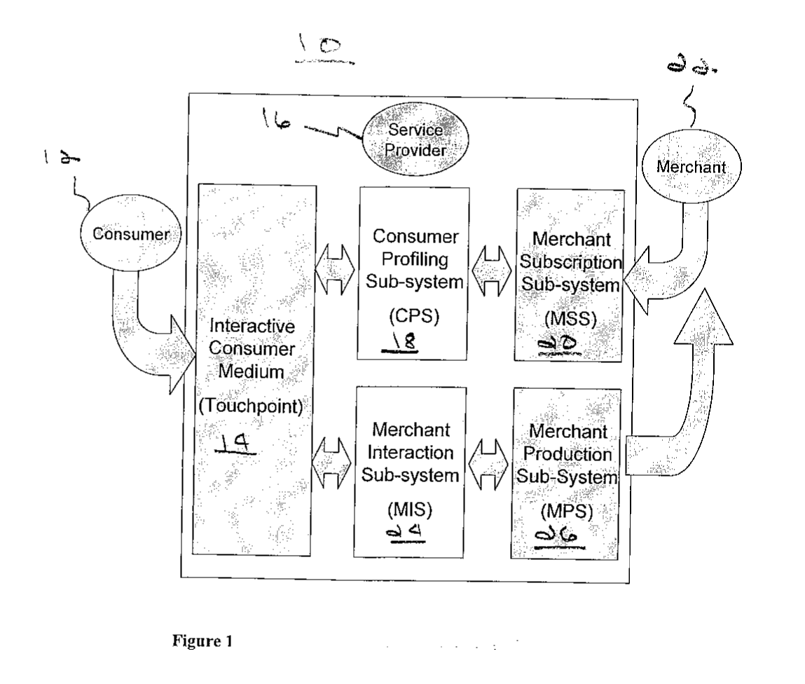

FIG. 1 presents the basic elements of the Pervasive Food-On-Demand system 10 and illustrates the points-of-access for each of the parties involved. Consumers 12 interact via a touchpoint 14 provided and/or supported by the Service Provider 16. This touchpoint 14 accesses the Consumer Profiling Sub-system (CPS) 18, optionally providing some form of identification of the Consumer 12. Various means of identification can be used such as: a credit or loyalty card; touchless identification tag (e.g., RFID (such as a speedpass) either handheld or automobile mounted); biometric information; subscriber number; etc. The Touchpoint 14 either alone or in combination with another device, also provides information about the user such as physical location (e.g. GPS coordinates from cell phone, portable computer or vehicular system), touchpoint type, touchpoint static location information such as fixed location of kiosks or gaming machines or the like, access point location (for non-GPS cell phones or wireless computer networks) or subscriber information such as from televisions or the like. Touchpoints 14 may also access the CPS 18 without any identifying information. In that case, it would be considered an anonymous transaction.

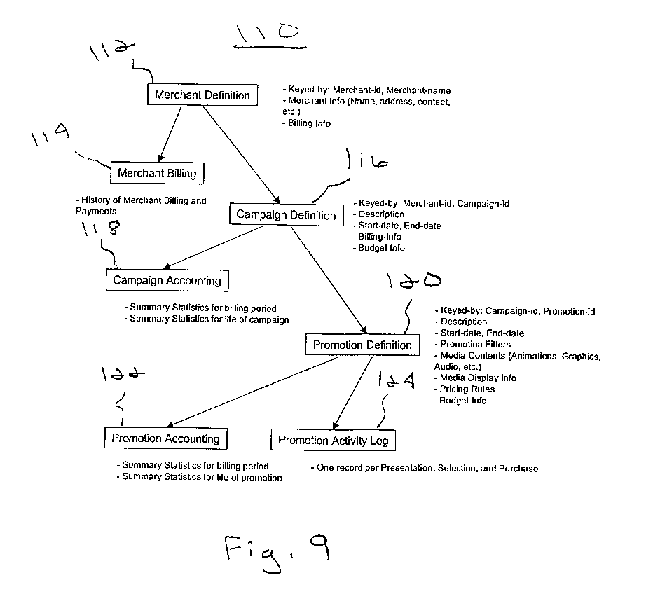

Merchants subscribe to the system using the Merchant Subscription Sub-system (MSS) 20. Additional details of the MSS 20 database table organization is set forth in connection with FIG. 9 below. The MSS system 20 allows the merchant to define the characteristics of their target Consumer base. It establishes the fee structure by which the Merchant 22 agrees to pay the Service Provider 16 (if any) for making their advertisements available to the Consumer 12. When a Consumer's information is provided to the CPS 18 by a Touchpoint 14, that information is used to construct a Consumer Profile. This profile is forwarded to the MSS 20, where it is matched to the database of Merchant information. Based on various factors, a set of “Best-Match” advertisements are selected and returned to the CPS 18 and back to the Touchpoint 14, which presents them in a medium-appropriate way to the Consumer 12.

If the Consumer 12 selects an advertisement, he/she may be presented with further advertising information, or if this is a “Transactional” advertisement, the Touchpoint 14 will invoke the Merchant Interaction Sub-system (MIS) 24 using the id of the merchant and the specifically chosen advertisement. Based on the nature of the subscription, the MIS 24 may present all of the Merchants products or may return a subset or special offer. The Consumer 12 may browse among the available items or may choose to configure and purchase one ore more of the presented items. Items may be highly configurable, allowing for example, specification of all of the desired ingredients on a submarine sandwich.

Once the items for the order are specified, the Consumer 12 may elect to pay for and finalize the order with the merchant 22. Payment may be done either centrally, through a facility provided by or through the Service Provider 16, or it may be done through the Merchant's payment processor by sending the payment information to the Merchant's outlet for processing. Merchant 22 may also elect to allow Payment-On-Pickup or Payment-On-Delivery options, in which case no payment information is provided. The list of ordered items along with payment, preparation, delivery and contact information (optional) is sent to the Merchant Production Sub-system (MPS) 26 where the payment is processed (centrally or remotely) and the order is inserted into the production system (e.g., Point-Of-Sale system) at the selected Merchant outlet. Outlets may be chosen manually by the consumer from a list of outlets provided by the MSS 20 or may be automatically determined by the MSS 20 based on location information provided by the Touchpoint 14. The order may be immediately presented to the personnel at the Merchant outlet for production, or may be stored for later presentation depending on the delivery time presented to the Consumer 12 as well as outlet based information such as workload, capacity, delivery-time, etc. An estimated “delivery-time” may be returned to the Consumer 12.

The MIS 24 may also include capabilities to provide suggested selling to the Consumer, Survey the Consumer, and/or Present specialized discounts or other incentives to the Consumer. Various utilization information is recorded and returned to the MSS 20 to be used for Merchant feedback or billing purposes. This may include the fact that an add was presented to the Consumer, but not selected; the fact that an add was viewed by the consumer, but did not result in a sale; the sale amount and items purchased for purchases resulting from the advertisement; as well as sale amount and items purchased for un-solicited purchases (i.e. purchases where the Consumer sought out the Merchant rather than responding to an advertisement. Other information which may be recorded and returned to the MSS 20 may include the results of various Consumer Surveys completed; the results of suggestive selling attempts (e.g., ignored, viewed, purchased); date and time of each occurrence; and Customer Id of each occurrence. Any of this information may be used for Merchant billing and/or accounting purposes within the MSS 20.

The Merchant Interaction Sub-System 24 performs several functions including merchant selection, merchant outlet selection, customer presentation, purchasing control, and customer profile updating. In the preferred embodiment, the Merchant Interaction Subsystem 24 is implemented as computer software code.

Outlet Selection.

When a consumer selects a merchant advertisement, that advertisement may expand and may for example, show a full-screen video advertisement. That expanded advertisement may provide a selectable function to invoke ordering. Alternatively, the initial selection of the advertisement may directly invoke ordering. In either case, when ordering is invoked, the Merchant Interaction Subsystem (MIS) 24 is activated for the designated merchant. The MIS first presents the consumer with a choice of outlets for the merchant. If only one outlet is available in the consumer's vicinity, or if the consumer has previously used a given outlet from the current touchpoint (based on Profile information) the Select Outlet step may be bypassed. The outlet selection function may automatically filter the list of outlets to those near the consumer's current location, or if the consumer's location is not known, may allow the consumer to specify filter criteria such as distance from a given zip code. This selection process is driven by a Merchant Location Database in the MIS 24 that may include the latitude and longitude or zip-code of each outlet.

Merchandise Selection.

Through interaction with the Merchant Production System 26, the set of merchandise available for purchase at the given outlet is determined. This includes the following capabilities: determination of available merchandise by time-of-day and day-of week; determination of item stocking levels and recognition of out-of-stock items; determination of item pricing; determination of available customizations or modifications to items; and determination of required specification fields for each item (e.g. size, flavor).

Customer Presentation.

The customer presentation rules for each merchant are defined in a touchpoint-independent way. The individual touchpoint is responsible for rendering those presentation rules in an appropriate way for the given medium. Presentation rules include: pictures or graphics to use for various items; relative order of item presentation; item presentation hierarchy; item customization rules—e.g., must select one option from group 1, 2 options from group 2 and zero or more options from group 3; promotion rules including up-selling based on items in this order, items in previous order, time-of-day, temperature, etc., discounts based on previous ordering, usage pattern, random lottery, or other aspects of the consumer's interaction, targeted consumer surveys based on any of the above and issuance of e-mail messages based on any of the above; presentation of previous orders or partial orders by the consumer, allowing single-touch re-ordering; ability to define delayed orders that will be queued until a future date or time; and ability to define recurring orders that are processed at defined intervals, for example every Monday at 8:00 AM; the third Thursday of each month at 1:30 PM for 4 months, or Monday—Thursday of this week at 11:30 AM.

Purchasing.

The Purchase Items function of the MIS 24 determines the types of payment mechanisms that can be used for the merchant. Payment types can include: Credit Card (merchant can limit the set of accepted cards); Stored Value (e.g. gift-card); Service Provider Billing (e.g. add to: Cable TV Bill, Phone Bill, Hotel Room Bill, etc.); Biometric-linked accounts (e.g. fingerprint); and Payment-On-Delivery/Payment-On-Pickup.

Payments can be authorized and settled either centrally or distributed to the individual outlet. Centralized payments are handled by the MIS, talking to the electronic payment service. Distributed payments are handled by forwarding the payment requests to the MPS at the appropriate merchant location, which will utilize the merchant's connection to its electronic payment service.

Once payment is confirmed, the order is sent to the MPS 26 for processing. The MPS 26 will either immediately send the data to local preparation, accounting, loyalty, and payment systems, or queue the order for future processing.

Customer Profile Update.

Once the order is complete, the MIS updates the consumer profile including: Items purchased; Visit Count; Last Visit Date; Total Purchases; Consumer Clustering Information; Last Outlet Selected; and Promotion Results, Etc. The profile is then sent to the CPS 18 for storage. If the order was not completed, then the fact that the order was started, but not completed, is noted in the profile and sent to the CPS.

The Merchant Production Sub-system (MPS) 26 performs various functions including providing access to the merchant's merchandise database, communicating with the in-store systems, providing delayed order queuing and workload management process and control. The Merchant Production Sub-system 26 communicates to the various systems (in-store systems) that are either at or accessible from the merchant site, such as Point-of-Sale systems (POS), electronic payment systems, loyalty systems and kitchen preparation systems. In the preferred embodiment, the merchant production subsystem 26 is implemented as computer software code. There is an instance of an MPS 26 for each merchant location. It may be resident at the merchant site, a service-provider location, or may be split between the two. In the case where it is resident at a service-provider location, the in-store systems must have a remote-access capability. In the case where the MPS 26 is split between the two locations, an agent (relay) would be present at the merchant location that enables remote communication to the in-store systems.

The MPS 26 provides the following functions: access to the merchant's Merchandise Database (read-only), which may include rules as to how to specify and or display merchandise items; access to the merchant's electronic payment capability. This may support credit cards, debit cards, private merchant accounts, or stored-value (e.g. gift-card) accounts or other evolving payment mechanisms; access to the merchant's order-preparation capability. This may include, for example, printers, fax-machines, kitchen-video displays, other mechanisms, or combinations of the above. There may be different combinations of mechanisms used for different merchandise items; access to the merchant's transaction accounting database for the purpose of recording the transaction in a manner that is consistent with orders placed at the merchant location or e.g., by phone; and access to the merchant's loyalty system (if present) for both sending transaction information (e.g. to earn points) and for receiving account balances such as earned items or discounts.

The MPS 26 must have the ability to communicate to multiple types of in-store systems, and must be able to map the syntactical and semantic differences among such systems to a common interface that is used by the Merchant Interaction Sub-system 24. For merchants that are lacking automated systems on site or with systems that cannot be integrated to, the MPS 26 provides a rudimentary (degenerate) capability for each of the merchant systems including: Preparation—Print a slip to one or more remote printers, remote display devices, or fax machines; Accounting—Write a transaction log or provide viewable reports; and Loyalty—Null.

The MPS 26 also allows orders to be submitted for immediate preparation or for delayed preparation. Orders submitted for delayed preparation are held at the MPS until the designated Start-of-preparation time of the order. At the designated time, the order will be sent to the preparation and accounting functions and the payment will be finalized. The system also allows recurring orders to be placed. Those orders will be left in the queue after being processed, with a new start-of-preparation time based on the designated repeat interval, repeat count and repeat-until date.

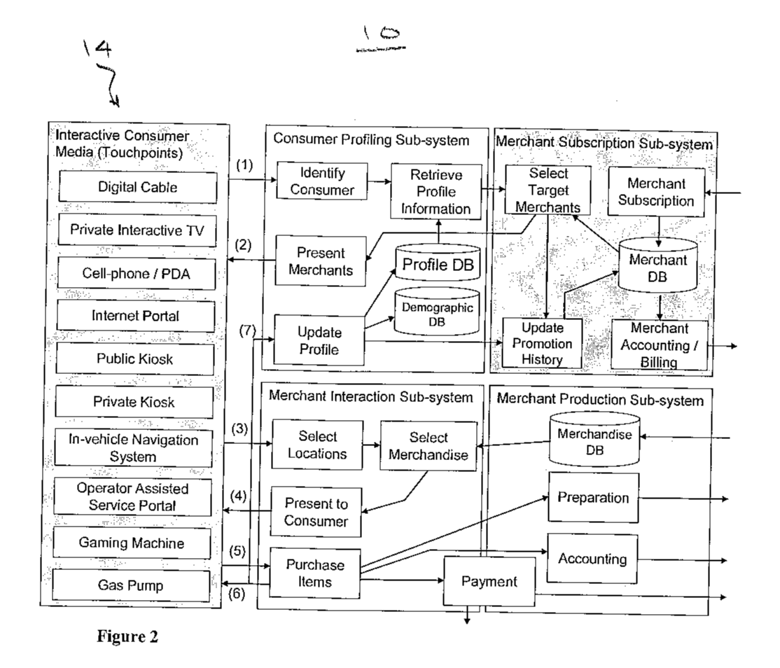

FIG. 2 Illustrates the data flow among sub-systems and details the interaction between the Consumer 12, as mediated by the Touchpoint 14, and the rest of the system 10. The following narrative describes the flow of a typical consumer interaction as mediated by a given-touchpoint 14. The act numbers below correspond to the labeled arrows in FIG. 2. A Customer 12 initiates standard service (e.g., TV) or requests shopping using touchpoint 14. The Customer is identified e.g., by swiping a card, based on subscriber information or through query to customer, act 1, wherein after the Customer's profile is retrieved from Profile Database, following which a prioritized list of targeted merchants is retrieved based on information from the Consumer Profile (e.g. past ordering history, preferences) and the Merchant Database (e.g. merchant advertising preference, how recently the merchant was displayed). An intelligent matching is made between the consumer and merchants based on the information in the Consumer Profile and the Merchant Database. The promotion history is updated to reflect the merchants that were presented to the user.

The chosen list of merchants is returned to the media driver and presented to the consumer, act 2. The consumer chooses one of the merchants to begin shopping, act 3. A list of applicable merchant locations is chosen based on consumer profile information (e.g. zip code) or the consumer's current location (e.g. GPS-Phone) and presented to the consumer. A set of merchandise to promote is chosen based on the contents of the merchant's Merchandise Database (at the Merchant site). This can be an intelligent decision based on the contents of the consumer profile.

A list of merchandise, along with presentation rules is returned to the media driver and presented to the consumer, act 4. The consumer chooses one or more items and (optionally) a payment method and (optionally) a location, act 5. The order is authorized for payment (e.g. credit authorization, billing authorization), using the Pavement function that may be centrally located or may be at the Merchant's site. The order is sent to the Merchant's Preparation system at the chosen location. The order may be scheduled for delivery or pickup and either as soon as possible or at a future date and time. The order is also sent to the Merchant's Accounting system at the chosen location. This may be combined with the merchant's preparation and payment systems or may be a stand alone system.

The status of the order is confirmed back to the customer, act 6. Next, the status and content of the order is sent to the Consumer Profiling Sub-system to give it the opportunity to reflect the latest purchase, act 8. The Consumer Profile Database is updated with data about the latest purchase. The Demographic Database is updated to reflect the additional purchase. The information is sent to the Merchant Subscription Sub-system to indicate the results of the merchant promotion.

The Consumer Profiling Sub-system (CPS) 18 is designed with the ability to support multiple Service Providers 16 and multiple types of touchpoints 14. This allows the collection of valuable demographic information regarding consumer behavior across individual Service Providers 16. The existence of such a powerful Consumer profiling database naturally raises concerns related to fraud, privacy and protection of Consumer information. It also raises questions regarding the privacy of proprietary Service Provider and Merchant information, which they may be unwilling to share with other Merchants or Service Providers. The CPS 18 provides a number of unique features that are specifically designed to reduce the ability to use the collected information for fraudulent purposes; protect the privacy of the consumer; track, categorize and understand consumer behavior; and provide subsets of consumer information to various Merchants 22 or Service Providers 16 needed to perform transactions requested by the Consumer 12. Specifically this sub-system 18 provides the ability to join multiple identification-media to a single Consumer Id; the ability to access consumer information using an identification-label (e.g., Credit Card Number), without storing that identification label; strong encryption of Consumer data; insulation of personal data from data needed by Service Providers or Merchants; tracking the behavior of individual consumers using an anonymous Consumer Id which cannot be related back to private consumer information (e.g., Name, address, phone-numbers); the ability to track Consumers' behavior and purchases with each Merchant without compromising proprietary Merchant information; the ability to tie a Consumer Id to important non-identifying information such as zip-code, age and sex; the ability for a Service Provider or Merchant to dynamically categorize (or “cluster”) Consumers based on customized criteria; the ability to prevent other Service Providers or Merchants from viewing the proprietary consumer and/or categorizations or clustering performed by a given Service Provider/Merchant; and the ability to dynamically add new attributes or counters to the profile.

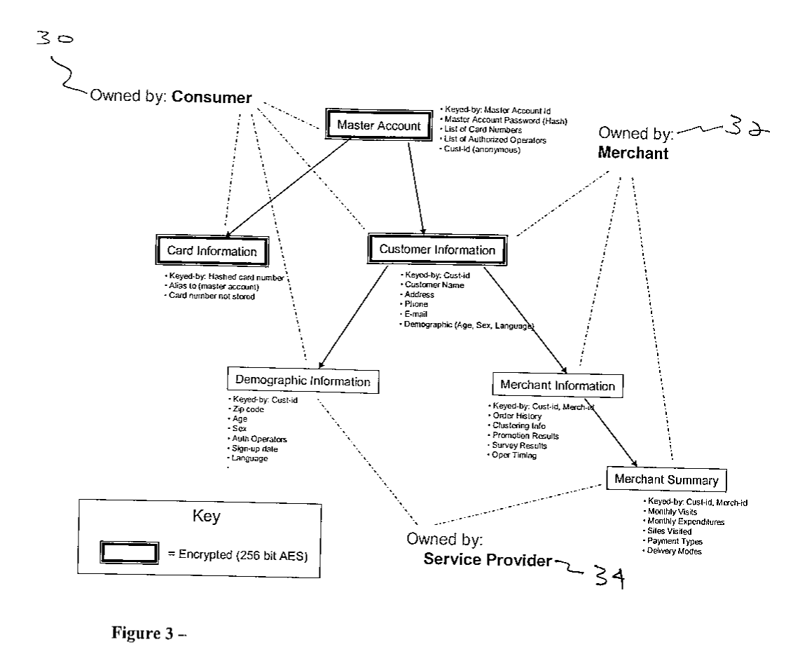

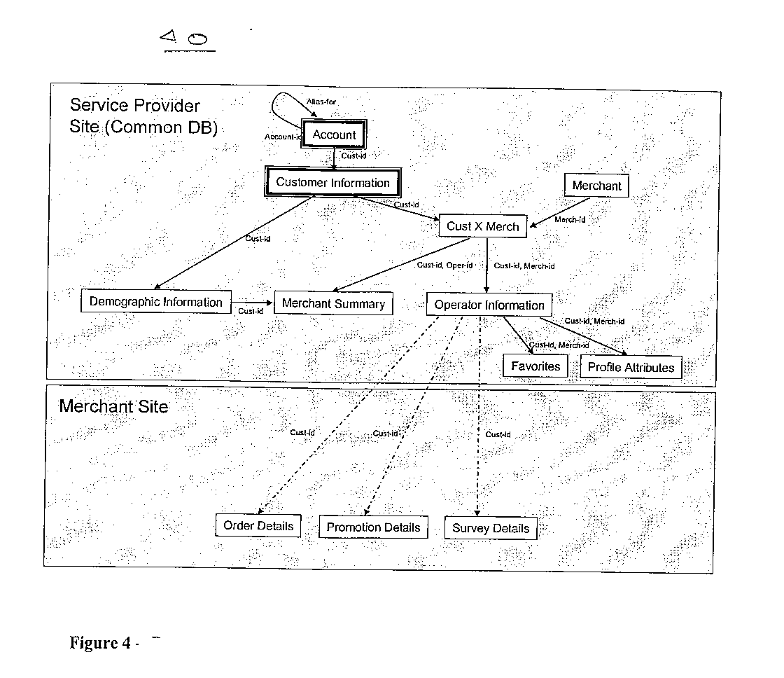

FIG. 3 schematically illustrates relative Customer Profile Data layout and “ownership” by the various system users including consumer owned data 30, Merchant owned data 32 and Service Provider owned data 34. The consumer “owned” data is encrypted to help prevent fraudulent use of this data. FIG. 4 schematically details the Consumer Profile Database 40 including related data sets and the location of the related data sets.

The Merchant Subscription Subsystem 20 provides the ability for the Merchants to be billed by the Service Provider for promotions on a number of bases including: Per Presentation, Per Selection, Per Purchase and Percentage of Purchase. The price for any of the bases above may be determined in a number of ways including: flat rate per time period (e.g. per day), fixed price per incident and auction based dynamic rating. Promotions may be filtered by a number of criteria including: Time of Day/Day of Week, Consumer clustering (e.g. Consumers that have previously purchased food, Females between 18 and 35, Consumers who have previously ordered Asian food, Consumers who have ordered two or more pizzas per order on average, or consumers who have ordered a specific drink type with their pizza order before). Consumer clustering is determined by the Consumer Profiling Subsystem including type of medium (e.g., Digital TV, PC, In-vehicle, Public Kiosk), current location, weather and Temperature, and Co-display constraints (e.g., not with a competitor, not with another of our own promotions).

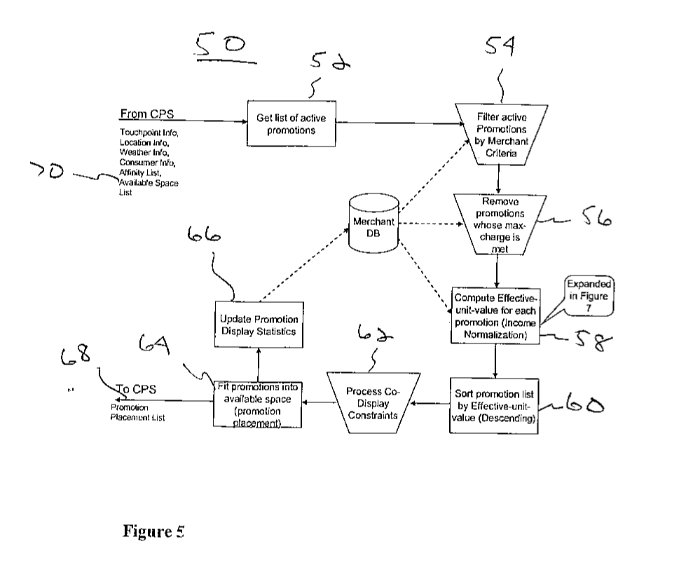

When a consumer is identified to the Consumer Profiling System 18, the consumer profile information, along with environmental information and the amount of space available for promotions on the particular touchpoint 14 is presented to the MSS 20 to determine the optimal promotions to present to the Consumer 12. The Promotion Selection process 50, FIG. 5, attempts to maximize the benefit to the Service Provider by selecting the promotions that are predicted to generate maximum advertising revenue. This process is performed by first determining all of the promotions that might apply during this period, act 52. This is done by comparing the Touchpoint Information, Location Information, Time and Date Information, Weather Information and Consumer Profile Information against the promotion filters, act 54 and returning the list of promotions that pass those filters. The process removes any promotions whose maximum-monthly-charge has been met, act 56, and normalizes the expected revenue from each promotion in list per unit of space taken by the promotion (Effective-unit-value) act 58. The promotion list is then sorted in descending order by Effective-unit-value, act 60, following which the system processes, for each item in the list, co-display constraints. If any previous item has a conflicting constraint or if this item has a constraint that conflicts with any previous item, the item is eliminated from the list.

The promotion selection process 50 also fits the promotions to the available promotion space act 64 using the Promotion Space List from the Promotion Placement process described herein below. The promotion log and promotion accounting are updated, act 66, to reflect the presentation of the promotions. This act may be deferred until the CPS confirms that the presentation was completed successfully. Finally, the process returns the promotions and their placement to the CPS, act 68.

One of the inputs to the Promotion Selection Process 50 is an Available Space List 70. This is a list of contiguous spaces available for promotions within the consumer's touchpoint device 14. Each space is defined by three integer quantities: horizontalUnits, verticalUnits, and temporalUnits. Each promotion's definition constrains the types of spaces that it can fill. These are specified by: Min horizontal-unit-size, Min vertical-unit-size, Max horizontal-unit-size, Max vertical-unit-size, Min time-units per presentation and Max time-units per presentation.

The goal of the Promotion Placement Process 50 is to maximize revenues for use of the available space. This is done by utilizing the largest spaces for the promotions with the largest Effective-unit-value. The algorithm below is used for this placement:

Sort the Available Space List by totalSpace (i.e. hUnits * vUnits * tUnits)
While unused space remains in the Available Space List:

PROMOTION_ADDED = False
For each promotion in the sorted promotion list:

For each space in the Available Space List:

If space.height >= promotion.min-vertical-unit-size
AND space.width >= promotion.min-horizontal-
unit-size AND space.duration >= promotion.min-
time-units:

Allocate area from space where:

Space.allocated-height =
MIN(space.height, promotion.max-
vertical-unit-size)
Space.allocated-width =
MIN(space.width, promotion.max-
horizontal-unit-size)
Space.allocated-duration =
MIN(space.duration,
promotion.max-time-units)

If full space was allocated:

Remove space from Available Space
List

Else:

Remove space from Available Space
List
Add new space to Available Space
List where:

Space.height, width and
duration are set to the
unallocated section of the
original space

Re-sort Available Space List

Remove promotion from sorted promotion
list
PROMOTION_ADDED = True
Continue to next promotion

If PROMOTION_ADDED == False:

# There are no more promotions that fit any
of the spaces. Break out of the loop.
Remove any unallocated spaces from
Available Space List

Return Available Space List as Allocated Space List

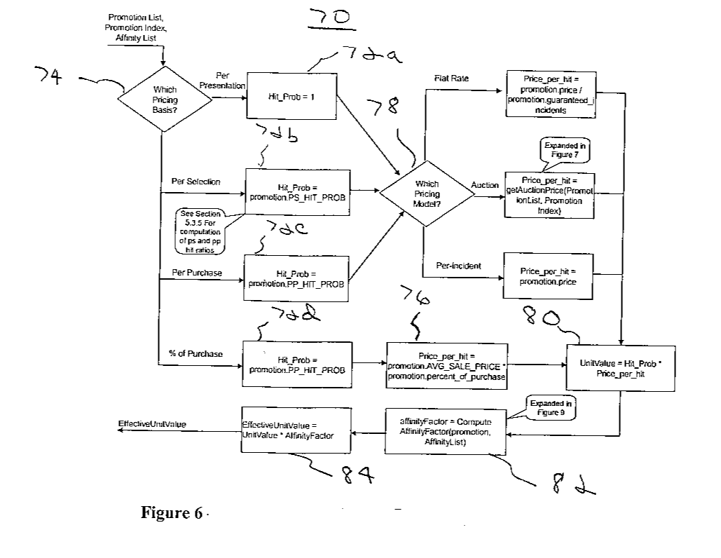

In order to effectively rank different promotions that were priced using different mechanisms, an income normalization method 70, FIG. 6, must be employed to convert all of the pricing methods to a single comparable metric. This metric is known as Effective-unit-value. It is an approximation of the promotion's projected income to the Service Provider per unit of space occupied on the Touchpoint. The process for determining this value varies with the different pricing methods.

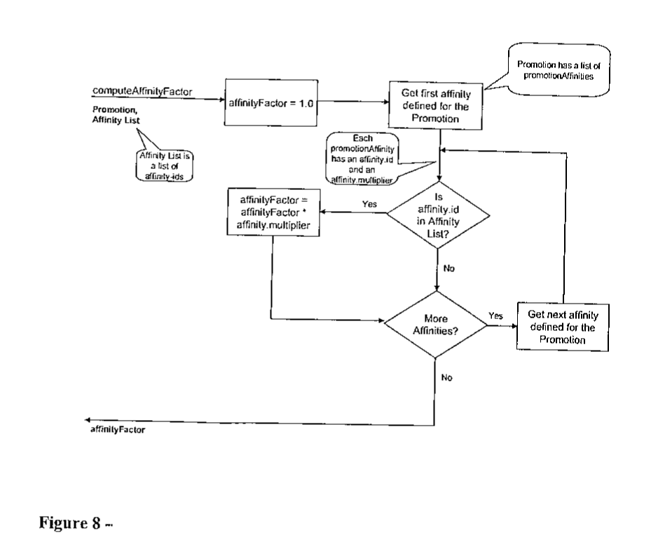

The process, as shown in FIG. 6, has five main components including: determining the probability (Hit_Prob) that the presentation of a promotion will result in an income generating event (i.e. “Hit”), act 72. A separate method for determining this probability (72a-72d) is determined and shown for each pricing basis, act 74. The process also determines the amount of income (Price_per_hit) that is expected to result from a “hit”, act 76. A separate method for determining this value is shown for each pricing model, act 78. The process also determines a preliminary price per unit of touchpoint space (unitValue) by multiplying the probability of a revenue-generating event by the expected unit price should the event occur, act 80. Also determined is if there are any “affinities” in the promotional environment (affinityList) that affect this promotion's value. Affinities (also referred to herein as “Temporal Affinity” are an external factor or factors that increase the value of a promotional activity. Examples include: non-promotion related touchpoint programming (e.g., TV show), sporting-events, gaming winnings, stock-market performance, etc. Affinities can also be negative, indicating that the value of the promotion is decreased by such external factors The process continues by computing the amount, if any, that the affinity factors skew the promotion price (affinityFactor), act 82 (which act is expanded in FIG. 8). Finally, the process computes the final expected income (effectiveUnitValue) for this promotion by multiplying the unitValue (from above) with the affinityFactor amount (from above), act 84.

Several Coefficients used in the Income Normalization Process are approximations of expected consumer behavior. Because these values can materially affect the results of the calculation and thus the realized revenues of the Service Provider, it is important that these approximations accurately reflect actual consumer behavior. Therefore, though they start out as an approximation, a feedback mechanism is employed that causes these numbers to converge on their normative values.

The specific Coefficients to which this calibration method are applied are:
GLOBAL_PS_HIT_PROB—the probability that a consumer will select a presented promotion. This is calibrated across all promotions, and is used as the starting point for a new promotion;
Promotion.PS_HIT_PROB—same as GLOBAL_PS_HIT_PROB above, except that it is calibrated for a given promotion; GLOBAL_PP_HIT_PROB—the probability that the presentation of a promotion will result in a purchase. This is calibrated across all promotions, and is used as the starting point for a new promotion; Promotion.PP_HIT_PROB—same as GLOBAL_PP_HIT_PROB above, except that it is calibrated for a given promotion;
Promotion.AVG_SALE_PRICE—this is a prediction of the size of a purchase that will be made by the consumer for a given promotion. Since purchase prices may vary widely from promotion to promotion, no attempt is made to calibrate this coefficient globally. The starting point for a given promotion may be a constant (e.g., 1.00) or may be the result of an estimate on the part of the merchant or service-provider.

Several methods may be used to calibrate these coefficients such as a moving average or a lifetime average, but for the purposes of this embodiment, a mechanism is employed that requires minimal record keeping as follows: a system-wide constant K (K>1) determines how quickly recent feedback will affect the approximation. A greater value of K will dampen the effect of individual samples. The process starts with any estimate of the expected norm (currentValue). It doesn't have to be very accurate (e.g. 1.0). For each result that is fed back (latestValue): set currentValue=(currentValue*(K−1)+latestValue)/K. It can be demonstrated that this algorithm will converge on the mean of all latestValues over time. The larger the value of K, the greater will be the damping effect, and the lesser will be the impact of an individual sample. The advantage of this approach is that it requires no historical record keeping beyond a single current value. For calibration of probabilities, the feedback values (latestValue) will always be zero (the event didn't occur) or 1 (the event did occur). Otherwise, the mechanism is identical.

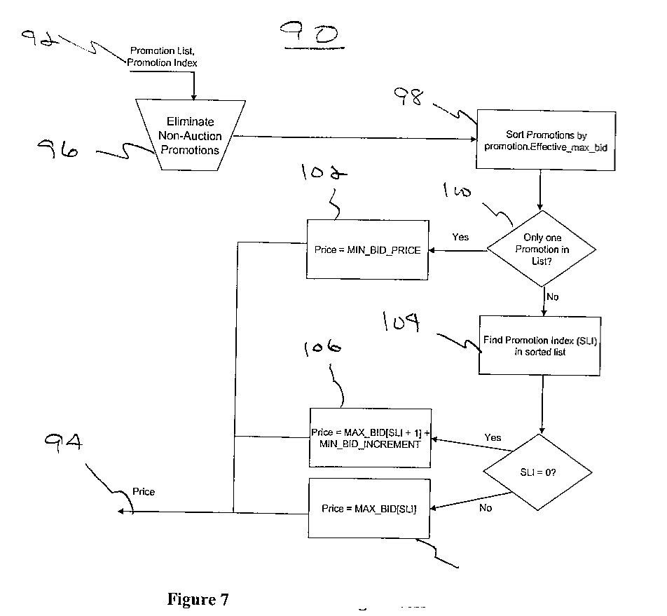

The present invention may also include an auction pricing method or process for pricing promotions. The acts involved in the auction process 90 are illustrated in FIG. 7. Auction priced promotions utilize the following controlling properties: Max_bid—the maximum amount that the merchant is willing to pay for a unit promotion; Maximum_per_period—the maximum the merchant is willing to pay for all presentations of this promotion during the billing period; current_charges—the total of promotion presentation charges during the current billing period; Remaining_allowance=Maximum_per_period—Current_charges; and Effective_max_bid—the lesser of Max_bid and remaining_allowance. The following constants are utilized: MIN_BID_PRICE—The price charged for an auction when only one promotion is in the promotion list and MIN_BID_INCREMENT—The smallest unit for raising a bid. The winning bidder will pay this much more than the Max_bid of the next highest bidder.

Input into the auction process is a list of promotions, and the index within that list of the promotion to be priced, 92. The process will output a single price 94, which is the price to be paid by the promotion indicated by Promotion Index. The process proceeds as follows: first, the PromotionList is filtered to remove any non-auction promotions, act 96. Next, the resulting list is sorted by Effective_max_bid, act 98. If there is only one item in the list, act 100, output the price as MIN_BID_PRICE 102, otherwise find the promotion specified by Promotion Index, act 104. If it is the first promotion in the sorted list (i.e. highest Effective_max_bid), output its price as the Effective_max_bid of the next promotion augmented by the minimum-bid-increment, act 106, otherwise, output its price as its Effective_max_bid, act 108.

On or more factors may be used to calibrate promotion pricing coefficients or to even override promotion pricing computation. One such override is termed a Temporal affinity price override computation and is illustrated in FIG. 8. The service-provider can determine a set of Potential Affinities to which a Merchant may wish to tie a promotion. Examples of these could include an action movie, a sporting event, a up closing on the stock market, a newscast, a women's show, a substantial win on a slot machine, Etc. The Promotion Definition allows a list of such affinities and a price-multiplier associated with each Affinity. It is anticipated that other mechanisms could be employed as well, such as an additive fee.

FIG. 8 above describes the computation for the affinity factor. Note that the Temporal Affinity process can also be used to indicate a repulsion or exclusion from certain events by using affinity multipliers between zero and one. A multiplier of zero would effectively zero the income expectation for a promotion when the corresponding potential affinity is present. A multiplier of 0.9 would act as a mild repellent.

FIG. 9 illustrates the various database table layouts 110 in the Merchant Subscription Subsystem 20.

Merchant Definition database 112 includes:
Merchant Name
Merchant Contact Information (Address, phone, etc.)
Etc.

Merchant Billing database 114 includes:
Merchant (Parent)
Billing history
Payment history.

Campaign Definition database 116 includes:
Campaign Name
Campaign Description
Campaign Contact Info
Campaign Start-date
Campaign End-date.

Campaign Accounting database 118 includes:
Campaign (Parent)
Summary statistics for billing period
   Promotions Presented
   Promotions Viewed
   Promotions Resulting in Sales
   Total sales amount
   Total advertising cost
Summary statistics for life of campaign
   Promotions Presented
   Promotions Viewed
   Promotions Resulting in Sales
   Total sales amount
   Total advertising cost.

The Promotion Definition database 120 includes:
Campaign (Parent)
Description
Start Date—If different from Campaign Start Date
End-date—If different from Campaign End Date
Promotion Filters
   Time-of-day/Day-of-week
   Location Filters
      By distance to outlet
      By zip code
      By touchpoint
   Consumer Filters
      Age
      Sex
      Cluster
      Income
      Etc.
   Weather/Temperature
   Touchpoint Type
   Co-Display Constraints
Temporal Affinities
   Affinity ID
   Unit-price modifier
Media Contents (Animations, Graphics, Audio, etc.)
Media Display Information
   Min horizontal-unit-size
   Min vertical-unit-size
   Max horizontal-unit-size
   Max vertical-unit-size
   Min time-units per presentation
   Max time-units per presentation
Pricing Basis
   Per presentation
   Per Selection
   Per Purchase
   Percent of Purchases
Pricing Model
   Flat Rate per Period
   Per-Incident
   Auction
Promotion Price (all pricing bases except Percent of Purchases, all pricing models except Auction)
Max Bid Price (auction only)
Promotion Percent (for Percent of Purchases)
Guaranteed Incidents (flat rate pricing only)
Maximum Per Period—Maximum allowed total promotion charges per promotion period
Current Charges—Total promotion costs since the beginning of the current promotion period (Automatic Feed from Promotion DB)
Initial Average Purchase (Percent of Purchase only)—This is the initial value to use. It will be calibrated as purchases are made.
Initial Per-Selection-Hit-Ratio (Per Selection only)—This is the initial value to use. It will be calibrated with consumer usage.
Initial Per-Purchase-Hit-Ratio (Per Purchase and Percent of Purchase only)—This is the initial value to use. It will be calibrated with consumer usage.

The Promotion Accounting database 122 includes:
Promotion (Parent)
Summary statistics for billing period
   Promotions Presented
   Promotions Viewed
   Promotions Resulting in Sales
   Total sales amount
   Total advertising cost
Summary statistics for life of campaign
   Promotions Presented
   Promotions Viewed
   Promotions Resulting in Sales
   Total sales amount
   Total advertising cost.

The Promotion Log database 124 includes:
Promotion (Parent)
Detailed Promotion History
   Time presented
   Time selected
   Time purchased
   Purchase amount
   Advertisement size
Advertisement cost

It should be emphasized that the above-described embodiments of the present invention are merely possible examples of implementations, simply set forth for a clear understanding of the principles of the invention. In addition, it should be further emphasized that the present invention has been explained in the context of a self-service food ordering system although this is not a limitation of the present invention as the invention may be utilized in any type of product or service ordering system. In addition, the present invention has been explained as implemented primarily in computer software although this is not a limitation of the present invention.

Many variations and modifications may be made to the above-described embodiment of the invention without departing substantially from the spirit and principles of the invention. All such modifications and variations are intended to be included herein within the scope of this disclosure and the present invention and protected by the allowed claims and their legal equivalents.

The invention claimed is:

1. A consumer ordering system, comprising:
an interactive consumer interface device, configured for at least allowing a consumer to interact with said consumer ordering system, for transmitting information provided by said consumer to said interactive consumer interface device, and for receiving information from an ordering system;
a consumer profiling system, responsive to said interactive consumer interface device, for receiving said information provided by said consumer to said interactive consumer interface device;
a merchant subscription system, configured for allowing a merchant of products or services to define one or more characteristics related to the merchants offer for sale of its products or services, and responsive to said consumer profiling system, for determining what information to provide to said interactive consumer interface device being utilized by a predetermined consumer;
a merchant interactive system, responsive to the interactive consumer interface, and configured for receiving at least a merchant identification information relative to a product, service or advertisement selected by a consumer, and for providing merchant specific information to said consumer; and
a merchant production system, responsive to said merchant interaction system and coupled to a merchant product or service provider, for receiving and scheduling for processing a consumer order for products or services.

2. The ordering system of claim 1, wherein said interactive consumer interface device is configured for at least allowing a consumer to identify him or herself to the ordering system.

3. The ordering system of claim 1, wherein said interactive consumer interface device is configured for at least allowing said interactive consumer interface device to provide present geographic location information of said interactive consumer interface device to said ordering system.

4. The ordering system of claim 1, wherein said interactive consumer interface device is configured to display merchant promotional or advertising information.

5. The ordering system of claim 1, wherein said merchant subscription system is configured to allow one or more merchants to define a details of a targeted consumer base, for determining what advertisements or promotional displays to provide to a consumer.

6. The ordering system of claim 1, wherein said merchant subscription system is configured to allow one or more merchants to enter a fee structure by which a merchant agrees to pay a service provider for providing advertisement or promotions to a targeted consumer.

7. The ordering system of claim 1, wherein said merchant identification information received by said merchant interaction system is based on a promotion or advertising displayed to a targeted consumer.

8. The ordering system of claim 1, wherein said merchant specific information provided to said consumer includes all of said merchant's products or services.

9. The ordering system of claim 1, wherein said merchant specific information provided to said consumer includes only some of said merchant's products or services.

10. The ordering system of claim 1, when said merchant interaction system is configured for receiving payment information from said consumer for products or services ordered.

11. The ordering system of claim 1, wherein said merchant interaction system allows said consumer to personalize products or services ordered.

12. The ordering system of claim 11, wherein said act of personalizing products or services ordered is selected from the group consisting of: choosing a product's color, flavor, condiment content, size and topping.

13. The ordering system of claim 1, wherein said consumer profiling system receives consumer identification information and is responsive to previously stored received consumer order information, and wherein said merchant interaction system is responsive to said consumer profiling system and configured for automatically identifying items preferred by the identified consumer based on information about the consumer's previous orders stored in memory and correlated with the consumer.

14. The ordering system of claim 1, wherein said merchant production system is configured for receiving ordered delivery information and for scheduling production of an order based on said received order delivery information.

15. The ordering system of claim 14, wherein said order delivery information is selected from the group consisting of: order pick up information, order remote delivery information, a time an order is to be ready information, and in a day in order is to be ready information.

16. The ordering system of claim 1, wherein said consumer profiling system maintains a profile on consumers who have previously ordered through said ordering system.

17. The ordering system of claim 16, wherein said profile includes an identification of the items preferred by each profiled consumer.

18. The ordering system of claim 17 wherein said merchant interaction system is responsive to said consumer profiling system and configured for automatically identifying items preferred by an identified consumer and for presenting items which can be purchased by said identified consumer based on said identified items preferred by said consumer.

19. The ordering system of claim 4, wherein said merchant promotional or advertising information is selected based on the group of information consisting of previous consumer ordering history, the contents of the consumer's current order and environmental factors.

20. The ordering system of claim 19, wherein said environmental factors are selected from the group consisting of temperature, geographic location of the consumer, time of day and local or international financial statistics.

21. The ordering system of claim 1, wherein said system presents surveys to a consumer at said interactive consumer interface device based upon one or more information datum consisting of previous consumer ordering history, the contents of the consumer's current order and environmental factors consisting of temperature, geographic location of the consumer, time of day and local or international financial statistics.

22. The ordering system of claim 10, wherein receiving and payment information from said consumer for products or services ordered includes receiving an order and paying for said order from a supplier of goods or services geographically local to said consumer.

23. The ordering system of claim 22, wherein said consumer order is received by said ordering system and directed into the production queue of a supplier of the ordered goods or services geographically local to said consumer.

24. The ordering system of claim 1, wherein said merchant production system receives a consumer order for immediate or delayed production.

25. The ordering system of claim 1, wherein said merchant production system is responsive to said consumer profiling system, for allowing a consumer to place a repeat order.

26. The ordering system of claim 1, wherein said merchant production system schedules for processing said consumer order for products or services based at least in part upon the workload of the supplier of goods or services ordered by the consumer.

27. The ordering system of claim 1, wherein said ordering system is configured to integrate into the production, accounting, consumer management, loyalty management and product or service payment systems in place at the supplier of goods or services ordered by the consumer.

28. The ordering system of claim 1, wherein said consumer ordering system supports any number of different types of interactive consumer interface devices.

29. The ordering system of claim 1, wherein said interactive consumer interface device is configured for receiving and displaying information from two or more merchants offering its products or services for sale, and wherein said ordering system allows two or more merchants of goods or services to compete for the right to display information to a consumer.

30. The ordering system of claim 29, wherein said two or more merchants of goods and services compete for the right to display information to a consumer based upon the price that said merchant is willing to pay for the right to display information to a consumer.

31. The ordering system of claim 30, wherein the price that said merchant is willing to pay for the right to display information to a consumer is determined by an auction.

32. The ordering system of claim 30, wherein the price that said merchant is willing to pay for the right to display information to a consumer is determined from the group consisting of a per presentation price, a per consumer purchase price, a percentage of purchase price, a flat rate per time period, and a fixed price per display incident.

33. The ordering system of claim 1, wherein said system allows merchants of goods or services to direct their advertising to a consumer using an interactive consumer interface device based on factors selected from the group consisting of time of day, day of the week, consumer's geographical location, whether, temperature, local or international financial statistics, type of interactive consumer interface device, display restrictions of said interactive consumer interface device, restrictions concerning the display of multiple advertising on said interactive consumer interface device and consumer clustering.

34. The ordering system of claim 30, wherein which of said two or more merchants of goods and services competing to display information to a consumer will receive the right to display said information to a consumer and wherein the price that said merchant is willing to pay for the right to display information to a consumer is determined by external affinity events.

35. The ordering system of claim 29 wherein said ordering system computes a price to charge a merchant for offering its goods or services to a consumer.

36. The ordering system of claim 35, wherein said ordering system periodically recomputes a price to charge a merchant for offering its goods or services to a consumer based upon actual consumer ordering data for said merchant's goods or services.

37. The ordering system of claim 1, wherein said interactive consumer interface device is configured for receiving and displaying advertisement from two or more merchants offering their products or services for sale, and wherein said ordering system automatically maps merchant advertisements to said interactive consumer interface device in such a way as to allow as many merchant advertisements as possible for a given consumer's interactive consumer interface device.

38. The ordering system of claim 1, wherein said consumer profiling system receives and stores consumer identification information, for identifying a consumer utilizing said ordering system through said interactive consumer interface device.

39. The ordering system of claim 38, wherein said consumer profiling subsystem identifies a consumer utilizing consumer identification information selected from the group consisting of a biometric device, a consumer-entered login, a credit card, a loyalty card, a touchless device and an identification through a computer network.

40. The ordering system of claim 39, wherein said consumer identification by said consumer profiling system is global to said ordering system.

41. The ordering system of claim 40, wherein said consumer identification may be accomplished at a first merchant location and recognized by a second merchant at a second merchant location.

42. The ordering system of claim 39, wherein said consumer identification information allows said consumer to be identified without providing access to confidential consumer information.

43. The ordering system of claim 38, wherein said consumer profiling subsystem identifies said consumer without storing consumer identification information.

44. The ordering system of claim 1, wherein said ordering system tracks consumer interaction activities with multiple merchants at one or more merchant's product or service provider outlets.

45. The ordering system of claim 1, wherein said ordering system allows multiple merchants to interact with a consumer, and wherein one of said multiple merchants may store consumer information received from said consumer and wherein said consumer information received and stored by one of said multiple merchants is not available to the other of said multiple merchants.

46. The ordering system of claim 1, wherein said ordering system is configured to dynamically group consumers into clusters.

47. The ordering system of claim 46, wherein each said clusters included two or more consumers having a common attribute.

48. The ordering system of claim 47. wherein said common attribute is selected from the group consisting of age, geographic location, gender, type of product previously ordered, quantity of product previously ordered and income.

49. The ordering system of claim 1, wherein said interactive consumer interface device is selected from the group consisting of a computer, a cell phone, a fixed position terminal, and interactive television, a gaming machine and an in-vehicle touch screen.

50. The ordering system of claim 1, further including a system for indicating to said ordering system a consumer's physical location.

51. The ordering system of claim 50, wherein said system for indicating to said ordering system a consumer's physical location includes one or more devices selected from the group consisting of a GPS capability in a cell phone, a portable computer, a vehicular system, the static location of a fixed terminal, an access point location and subscriber information.

52. The ordering system of claim 51, wherein said system for indicating to said ordering system a consumer's physical location includes said interactive consumer interface device.

53. The ordering system of claim 50, wherein said ordering system utilizes said consumer's physical location to determine whether or not a merchant advertisement or promotion is appropriate for said consumer.

54. The ordering system of claim 50, wherein said ordering system utilizes said consumer's physical location to determine which one of a plurality of product or service provider a let's should receive and produce said consumer's order.
